(19) United States
(12) Patent Application Publication
(10) Pub. No.: US 2005/0285423 A1
(43) Pub. Date: Dec. 29, 2005

(54) Stopper for spare tire

(76) Inventor: Dae-Sub Song, Hwaseong-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/156,295

(22) Filed: Jun. 17, 2005

(30) Foreign Application Priority Data
Jun. 23, 2004 (KR) 10-2004-0046900

(51) Int. Cl. B62D 23/00

(52) U.S. Cl. 296/35.2

(57) ABSTRACT

A system that prevent the spar tire of a vehicle from being thrusted forward into the fuel tank during a vehicle collision is disclosed. The forward motion of the spare tire from the rear collision is feasibly converted, thereby preventing the spare tire from directly impacting a fuel tank placed in front of the spare tire and improving vehicle stability. A stopper for the spare tire includes a forward motion blocking arm and a direction conversion arm. The system also includes a pivot axis located parallel to a lateral direction of the vehicle, a forward motion blocking arm protruding out from the pivot axis toward the front of the spare tire installed underneath the vehicle body and a direction conversion arm protruding out from the pivot axis between an upper portion of the spare tire and the lower portion of the vehicle body.

### CROSS-REFERENCE TO RELATED APPLICATIONS

The present application is based on, and claims priority from, Korean Application Serial Number 10-2004-0046900, filed on Jun. 23, 2004, the disclosure of which is hereby incorporated by reference herein in its entirety.

### FIELD OF THE INVENTION

The present invention relates generally to automobile spare tires, and, more particularly, to a stopper adapted to restrain the movement of the spare tire toward the front of the vehicle in a vehicle rear collision.

### BACKGROUND OF THE INVENTION

Typically, a vehicle spare tire is mounted underneath the rear floor of a vehicle, and a fuel tank is disposed in front of the spare tire. When a rear collision occurs to a vehicle having the above configuration, the spare tire is thrusted toward the front of the vehicle, and the fuel tank may become damaged by the spare tire, thereby causing fuel leakage. Therefore, there is a need for a system which prevents damage to a fuel tank resulting from a spare tire being thrusted into the fuel tank during a rear end collision.

### SUMMARY OF THE INVENTION

Embodiments of the present invention are provided to feasibly convert the forward motion of the spare tire from a rear collision, thereby preventing the spare tire from directly impacting onto an object (e.g., a fuel tank) disposed in front of the spare tire.

A stopper for a spare tire is fixed at a lower portion of the vehicle body via a pivot axis, which is parallel to a lateral direction of the vehicle. The stopper includes a forward motion blocking arm protruding out from the pivot axis toward the front of a spare tire installed underneath the vehicle body. A direction conversion arm protrudes out from the pivot axis between an upper portion of the spare tire and a lower portion of the vehicle body.

The forward motion blocking arm and the direction conversion arm are integrally connected and form an L-shaped configuration, and a hole is formed at the connecting portion of the forward motion blocking arm and the direction conversion arm to be used to form the pivot axis.

The forward motion blocking arm protrudes from the pivot axis toward a lower portion of the vehicle body, and one end of the forward motion blocking arm is bent toward the rear of the vehicle.

The direction conversion arm has at one end thereof an enlarged cross-sectional part that is enlarged in its cross-sectional thickness, and the surface of the enlarged cross sectional part is smoothly curved.

### BRIEF DESCRIPTION OF THE DRAWINGS

FIG. 1 is a perspective view of a stopper for a spare tire according to an embodiment of the present invention; and

FIG. 2 illustrates an operation of the stopper of FIG. 1.

### DETAILED DESCRIPTION OF THE PREFERRED EMBODIMENTS

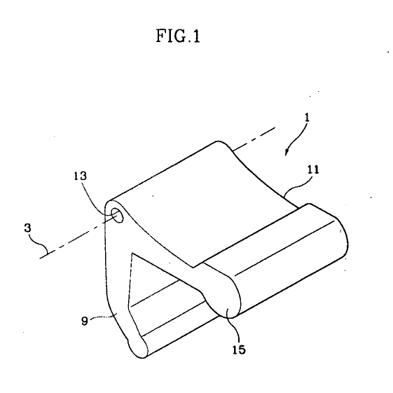

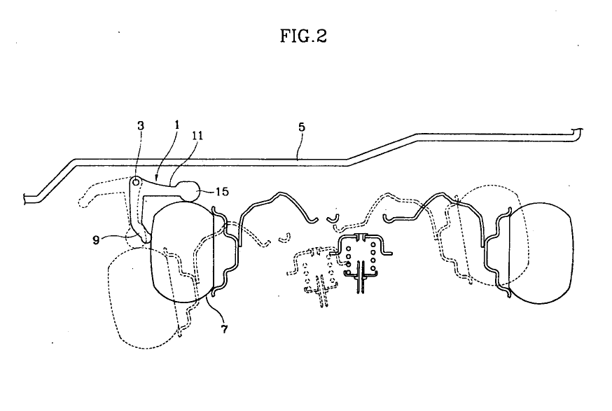

Referring to FIGS. 1 and 2, a stopper 1 for a spare tire is fixed at a lower portion of a vehicle body 5 via a pivot axis 3, which is parallel to the lateral direction of the vehicle. The stopper 1 includes a forward motion blocking arm 9 protruding out from the pivot axis 3 toward the front of the spare tire 7 installed underneath the vehicle body 5. A direction conversion arm 11 protrudes from the pivot axis 3 between the upper portion of spare tire 7 and lower portion of vehicle body 5.

The forward motion blocking arm 9 and direction conversion arm 11 are integrally connected and form an L-shaped configuration. A hole 13 is formed at the connecting portion of forward motion blocking arm 9 and direction conversion arm 11, which is used to form pivot axis 3. The pivot axis 3 of the stopper 1 is formed with the hole 13 and a pin, bolt or the like at the bottom of the vehicle body 5.

The forward motion blocking arm 9 protrudes from the pivot axis 3 toward the ground underneath the vehicle body 5, and the end of forward motion blocking arm 9 is bent toward the rear of the vehicle. This configuration allows the forward motion blocking arm 9 to rapidly receive kinetic energy from the forwardly moving spare tire 7, due to the rear collision.

The direction conversion arm 11 has at one end an enlarged cross-sectional part 15 that is enlarged in its cross-sectional thickness. The surface of the enlarged cross sectional part 15 is smoothly curved. This permits the direction conversion arm 11 to push the spare tire 7 toward the ground underneath the vehicle without damaging the spare tire 7 and the stopper 1 to have a large rotational inertia.

With reference to FIG. 2, the solid lines indicate a normal state for the stopper 1 of the spare tire 7, and the dashed lines indicate the operation state of the stopper 1 when a vehicle rear collision occurs. Under normal conditions, the forward motion blocking arm 9 firmly supports the front of the spare tire 7 to stably install the spare tire 7 to the vehicle body 5. If the spare tire 7 moves toward the front of the vehicle due to a rear collision, the kinetic energy of the spare tire 7 is transmitted to the forward motion blocking arm 9 of the stopper 1. The stopper 1 pivots in relation to the pivot axis 3 by the kinetic energy transmitted to forward motion blocking arm 9, and thus, the direction conversion arm 11 integrally connected with the forward motion blocking arm 9 pivots downwardly.

When the direction conversion arm 11 pivots downwardly, the enlarged cross-sectional part 15 of the direction conversion arm 11 presses the upper surface of the spare tire 7 to downwardly move the spare tire 7. Therefore, the spare tire 7 moves toward the lower side of the vehicle body 5 and simultaneously toward the front of vehicle, thereby preventing a collision with components (e.g., fuel tank or the like) installed at the front of the spare tire 7.

As apparent from the foregoing, there is an advantage in that the forward motion of the spare tire due to a vehicle rear collision is easily converted, thereby improving the vehicle stability by preventing the spare tire from directly impacting a fuel tank installed in front of the spare tire.

While the foregoing description represent various embodiments of the present invention, it will be appreciated that the foregoing description should not be deemed limiting since additions, variations, modifications and substitutions may be made without departing from the spirit and scope of the present invention. It will be clear to one of skill in the art that the present invention may be embodied in other forms, structures, arrangements, and proportions and may use other elements, materials and components. The present disclosed embodiments are, therefore, to be considered in all respects as illustrative and not restrictive, the scope of the invention being indicated by the appended claims and not limited to the foregoing description.

1. A stopper for a spare tire being fixed at a lower portion of a vehicle body via a pivot axis, which is parallel to a lateral direction of a vehicle, the stopper comprising:
a forward motion blocking arm protruding out from said pivot axis toward a front portion of said spare tire installed underneath said vehicle body; and
a direction conversion arm protruding out from said pivot axis between an upper portion of said spare tire and a lower portion of said vehicle body.

2. The stopper of claim 1, wherein said forward motion blocking arm and said direction conversion arm are integrally connected and form an L-shaped configuration, and a hole is formed at a connecting portion of said forward motion blocking arm and said direction conversion arm to be used to form said pivot axis.

3. The stopper of claim 1, wherein said forward motion blocking arm protrudes from said pivot axis toward the ground underneath said vehicle body, and the end of said forward motion blocking arm is bent toward a rear of the vehicle.

4. The stopper of claim 1, wherein said direction conversion arm has at one end an enlarged cross-sectional part that is enlarged in its cross-sectional thickness, and the surface of said enlarged cross-sectional part is smoothly curved.

5. A system, comprising:
a pivot axis located parallel to a lateral direction of a vehicle;
a forward motion blocking arm protruding out from said pivot axis in a first direction;
a direction conversion arm protruding out from said pivot axis in a second direction, wherein said forward motion blocking arm and said direction conversion arm are rigidly attached at said pivot axis and form an angle between them.

6. The system of claim 5, wherein said angle is 90 degrees.
